(19) United States
(12) Patent Application Publication
(10) Pub. No.: US 2026/0357619 A1
(43) Pub. Date: Nov. 12, 2026

(54) Reversed Action Tension Control Mechanism

(71) Applicant: Defang Yuan, Ottawa (CA)

(72) Inventor: Defang Yuan, Ottawa (CA)

(21) Appl. No.: 19/202,541

(22) Filed: May 8, 2025

(51) Int. Cl. E05B 75/00

(52) U.S. Cl. CPC E05B 75/00

(57) ABSTRACT

A reversed action mechanism is developed in this invention. When the rotation axis of the middle ratchet and the free end of the middle ratchet is at the opposite sides of the stop key when the over-tightening mechanisms are engaged, the false activation is prevented. In the innovation, the rotation axis is placed at the left-most end of the middle ratchet and mounted on the small-end the single strand, the movement of the middle ratchet is reversed when a resistant force is applied from inner side of the handcuff, and the rotation of the middle ratchet is clockwise other than counterclockwise around its axis as in prior arts, and all interactions and forces of related parts are changed, the false activation is basically prevented, and the handcuff never gets malfunctioned even in the worst circumstance.

### BACKGROUND OF THE INVENTION

Over-tightening of a handcuff causes wrist injuries. Different over-tightening mechanisms are developed. But all prior arts are not fully satisfied, injuries and malfunctions still exist in some circumstances. This invention is to overcome the problems in US 2020/0131807 A1 (Jonathan Garry Heiney), application number (US) 17378372 (Defang Yuan) and application number (US) Ser. No. 17/555,431 (Defang Yuan). In prior art applications, the over-tightening mechanisms can be activated unwantedly in operation and proven not reliable in violent scenarios, which are often encountered in everyday law enforcement. The unwanted activation is named as a false activation, it is a phenomenon where the over-tightening mechanisms is activated before the handcuff is properly and securely applied on a wrist, and further operation of the handcuff is compromised. False activation is considered as a disaster failure or life threatening for police officers in frontlines, and unacceptable even if only occurs accidently. A reversed action mechanism is presented in this invention. Analyses show that when the rotation axis of the middle ratchet and the resistant force are at the same side of the stop key when engaged, the false activation is inevitable. In the innovation, the rotation of the middle ratchet is reversed when a resistant force is applied from inner side of the handcuff, and the rotation of the middle ratchet is clockwise other than counterclockwise around rotation axis as in prior arts, and all interactions and forces of related parts are changed, the false activation is basically prevented, and the handcuff never gets malfunctioned even in the worst circumstance.

### SUMMARY OF THE INVENTION

A reversed tension control mechanism,
the mechanism comprises a single strand, a middle ratchet, a spring, and a stop key,
the single strand has a rivet, a big-end, a small-end, and at least 9 teeth,
the big-end of the single strand is the end near the rivet,
the small-end of the single strand is the end far away from the rivet, it is the opposite end of the big-end,
the single strand rotates around the rivet when pushed,
the middle ratchet has a rotation axis, a left-most end and a up-right end, and at least 5 teeth,
the left-most end of the middle ratchet is connected to the small-end of the single strand via the rotation axis,

The up-right end of the middle ratchet is a free end, the up-right end of the middle ratchet is to rotate around the rotation axis when pushed,
the middle ratchet rotates clockwise around the rotation axis when pushed by a resistant force from inner side of the middle ratchet, when the teeth of the middle ratchet contact the stop key, the middle ratchet engages with the stop key and stops rotating, any further clockwise rotation of both the middle ratchet and the single strand are prevented,
the single strand, the middle ratchet, the rotation axis and the stop key are arranged in such positions that when the middle ratchet engages with the stop key, the rotation axis and the up-right end of the middle ratchet are at the opposite sides of the stop key.

The spring and the rotation axis are at the opposite sides of the stop key when the middle ratchet engages with the stop key.

When the middle ratchet is pushed by the spring, a tangential force of the spring is created at the position where the middle rachet and the spring are contacting,
when the middle ratchet engages with the stop key, a reaction force of the middle ratchet is a corresponding force created by the spring through the position of the stop key,
the reaction force of the middle ratchet is greater than the tangential force of the spring.

The distance between the rotation axis and the position of the stop key is smaller than the distance between the rotation axis and the position where the middle rachet and the spring are contacting.

A tangential angle is defined as the angle of the middle ratchet moving through the position of the stop key when the middle ratchet rotates counterclockwise around the axis,
the tangential angle is greater than 90 degrees.

All teeth of the middle ratchet are on the right side of the rotation axis when the middle ratchet engages with the stop key.

All teeth of the middle ratchet are equal in pitch,

All teeth of the single strand are equal in pitch,

The teeth's pitch of the middle ratchet is equal to the teeth's pitch of the single strand.

The tooth angle of the stop key is between 30 degrees and 90 degrees.

The stop key has only one tooth at least.

The stop key has more than one tooth, the pitches of the teeth of the stop key are equal, and the teeth's pitch of the stop key is equal to the teeth's pitch of the middle ratchet.

The tooth angle of the stop key is never bigger than 90 degrees to prevent false activation.

The rotation axis of the middle ratchet and the resistant force applied from inner side of the middle ratchet are at the opposite sides of the stop key to prevent false activation

Principle analyses are described in this invention, and some embodiments of the mechanisms are presented with details.

### BRIEF DESCRIPTION OF THE DRAWINGS

FIG. 1 is an illustration of the prior art in US 2020/0131807 A1 (Jonathan Garry Heiney), wherein the rotational axis 184 is positioned at the right side of the teeth of middle ratchet 186.

FIG. 2 is another illustration of the prior art in US 2020/0131807 A1 (Jonathan Garry Heiney), wherein the rotational axis 184 of middle ratchet 186 is positioned at the right side of stop key 196.

FIG. 3 is an illustration of the prior art in application Ser. No. 17/378,372 (Defang Yuan), the illustration is mirrored to keep all the orientations same in the specification, wherein the rotation axis 20 is positioned at the right side of the teeth of middle ratchet 104.

FIG. 4 is an illustration of the prior art in application Ser. No. 17/555,431 (Defang Yuan). Wherein the rotation axis 20 of the middle ratchet 104 is positioned at the right side of the stop key 1205.

FIG. 5, reference directions and positions defined in the specification.

FIG. 5A, a mechanism in prior arts, rotation axis is on the up-right end.

FIG. 5B, a mechanism when teeth of middle ratchet are sticking with stop key in prior arts.

FIG. 5C, an extended protection angle/area of prior arts. Where false activation is more likely.

FIG. 5D, a reduced protection angle/area of prior arts, false activation is less likely but exists.

FIG. 6A, a present invention, rotation axis 510 is at the left-most end of the middle ratchet.

FIG. 6B, the prior arts, rotation axis 511 is at the up-right end of the middle ratchet.

FIG. 6C, a present invention, rotation trajectories of middle ratchet 502, only teeth are shown.

FIG. 6D, the prior arts, rotation trajectories of middle ratchet 502, only teeth are shown.

FIG. 7A, a present invention, relations of Rs, Rm, Fu and Fs. Where Fu>Fs.

FIG. 7B, the prior arts, the relations of Rs, Rm, Fu and Fs. Where Fu<Fs.

FIG. 8A, a present invention, relations of angle 520 and angle 530. Where a>0.

FIG. 8B, in prior arts, relations of angle 520 and angle 530. Where a<0.

FIG. 9A, a present invention, relations of angle 520 and angle 530. Magnified.

FIG. 9B, prior arts, relations of angle 520 and angle 530. Magnified.

FIG. 10A, a present invention, rotation trajectory of the middle ratchet.

FIG. 10B, prior arts, rotation trajectory of the middle ratchet.

FIG. 11, a present invention, relations of the single strand, the middle ratchet, the spring, the stop key, force 508 and the rotation axis 510.

FIG. 12, the present invention, relations of the single strand, the middle ratchet, the spring, force 508 and the rotation axis.

FIG. 13, the present invention, relations of the middle ratchet, the stop key and the rotation axis. In engaged status, where force 507 is applied,

FIG. 14, the present invention, relations of the middle ratchet, the stop key and the rotation axis. In disengaged status, where force 507 is removed.

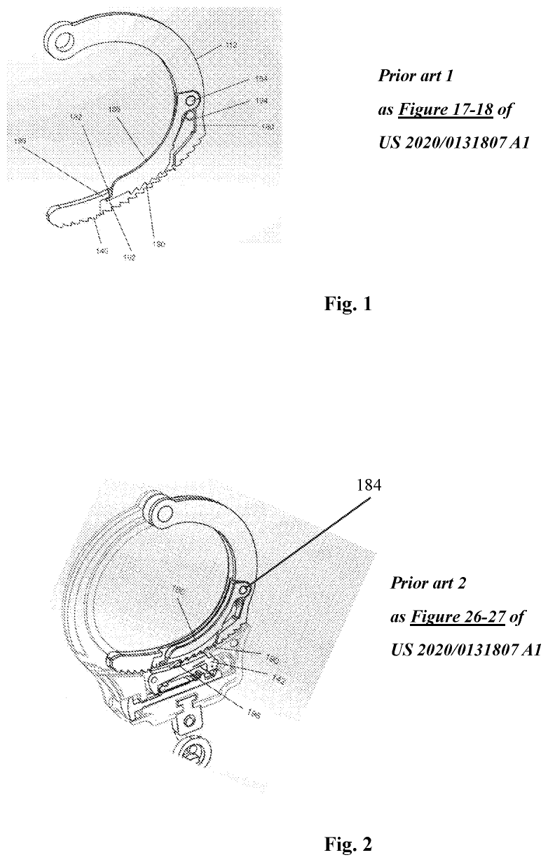

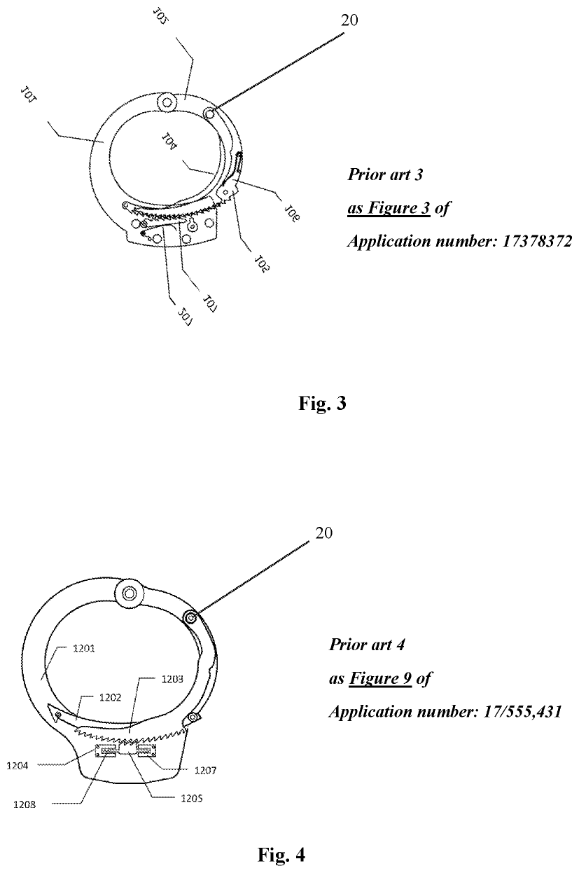

Table 1 is a summarization of distinctive differences between present invention and prior arts.

### DETAILED SPECIFICATION OF THE INVENTION

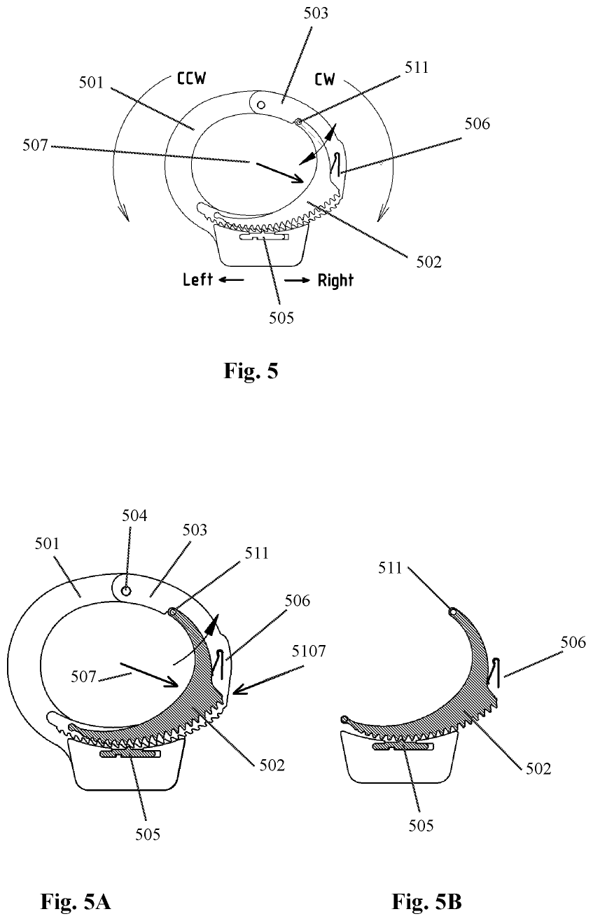

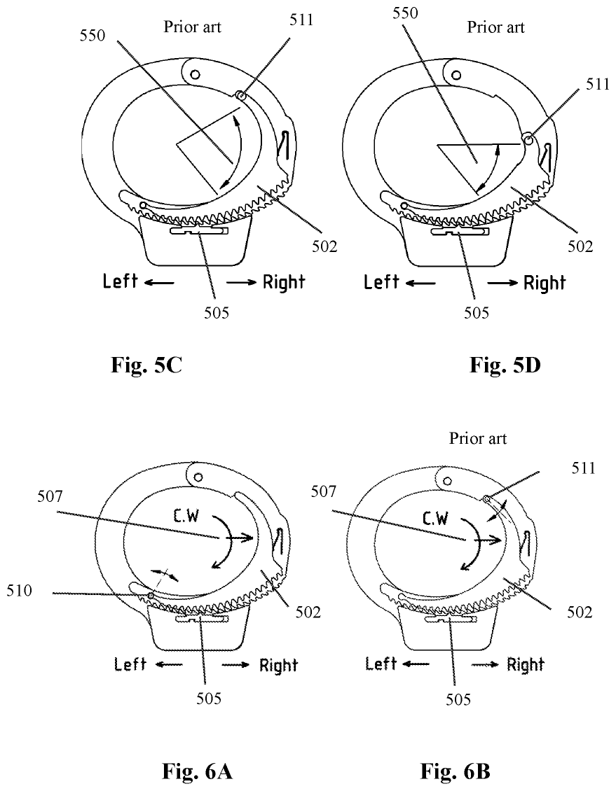

Refer to FIG. 5, it is an illustration of reference directions used in this specification, these directions are based on the specific orientation of the handcuff as illustrated, wherein CW is clockwise, CCW is counterclockwise; and up, down, right and left are relative positions or directions of different parts.

In FIG. 5, the handcuff comprises:
a double strand 501,
a single strand 503 with teeth, a rivet, the smaller end of 503 is defined as a small-end, which is far away from the rivet of 503; the bigger end of 503 is defined as a big-end, which is near the rivet.
a spring 506, the spring is in contacting with a middle ratchet 502, this contacting position is defined as a contacting position,

The middle ratchet 502 is with teeth, the left-most end is defined as a left-most end, the up-right end is defined as a up-right end,
a stop key 505 with at least one tooth,
All teeth have same pitches, the teeth's pitch is the distance between two adjacent teeth,
a resistant force 507, which is applied from the inner side of 502,
and a rotational axis 511.

In FIG. 5A, it is noticed that both the rotation axis 511 and resistant force 507 is at the right side of stop key 505. In other words, the contacting area between wrist and the middle ratchet 502 falls at the right side in referring the stop key 505. The contacting area is also the position of equivalent resistant force 507.

When the tightening force 5107 is applied on the single strand 503 from outside, 503 and 502 rotate in CW around the rivet 504, the handcuff is to be closed, and a wrist is to be restrained in between 501 and 503.

When 502 touches the wrist, a resistant force 507 is applied on the inner side of 502, when the force 507 is greater than the force applied by the spring 506 equivalently, the middle ratchet 502 rotates around rotation 511 in CCW; when the tooth/teeth of 502 touches the stop key 505, the rotations of both the 503 and 502 are stopped, further tightening of the handcuff is prohibited, and overtightening injury is expected to be prevented.

When the resistant force 507 is removed, the 502 is expected to rotate in CW around 511 by the spring 506. and returns to its free position, and the handcuff is ready for operation again. The free position is a position where the middle ratchet does not engage with the stop key.

But, as far as the rotation axis 511 and the resistant force 507 are at same side of the stop key 505, false activation is inevitable. The over-tightening mechanisms of the handcuffs based on prior arts 1 to 4 are not fully satisfied in real application scenarios.

There are at least two problems based on the disclosures in prior arts.

1), At certain positions of the handcuffing, after the over-tightening mechanism is trigged, the middle ratchet can not return to its free position automatically, further operation of the handcuff is prohibited. This is described as a false activation, it may impose great risks to both the law enforcement officer and/or the restrained person, because more often the handcuffing is applied in struggling or being non-compliant conditions. Any equipment failure or hesitation will be dangerous or even life-threatening.

2), For certain wrist sizes, or at certain angles, the over-tightening mechanism can not work properly after handcuff is applied, wrist injuries still occur.

Refer to FIG. 5A, the handcuff is based on prior arts, the mechanism is trigged by resistant force 507, middle ratchet 502 rotates around rotation axis 511, middle ratchet 502 stops when meets and engages with stop key 505, the over-tightening protection is activated, further tightening of the handcuff should be prevented.

In certain conditions, after the force 507 is removed, the middle ratchet keeps sticking to stop key 505 due to the inherent characteristics of the mechanism, further operation of the handcuff is compromised, false activation occurs. This is shown in FIG. 5B.

For certain wrist sizes and angles, as shown in FIGS. 5C and 5D, when the contacting position between the restrained wrist and middle ratchet 502 is outside of the protection area 550, the mechanism cannot be activated, and over-tightening protection is failed.

The protect area 550 is also expressed as protection angle 550 or covering angle 550.

Problem 1) and 2) cannot be overcome by only adjusting sizes and part positions.

In FIG. 5C, by moving rotation axis 511 toward the big-end of the single strand, the covering angle 550 is extended but the sticking more likely occurs because the tangential angle becomes smaller. Detailed explanation is in FIG. 9B.

At the outside area of the covering angle 550, the over-tightening protection mechanism can not be activated. The larger the covering angle 550, the more the protection area is, but the smaller the tangential angle, false activation are more likely encountered.

FIG. 5D, by moving rotation axis 511 away from the big-end of the single strand, the sticking less likely occurs but the covering angle 550 is reduced because the tangential angle becomes bigger.

Detailed explanation is in FIG. 9B.

It can be seen from FIG. 5C and FIG. 5D that the false activation cannot be eliminated without compromising the over-tightening prevention function, or by reducing the covering angle 550.

As far as the covering angle 550 and the rotation axis 511 are at the same side of the stop key 505, false activation always exists.

The solution is to put the rotation axis and the resistant force at the opposite sides of the stop key.

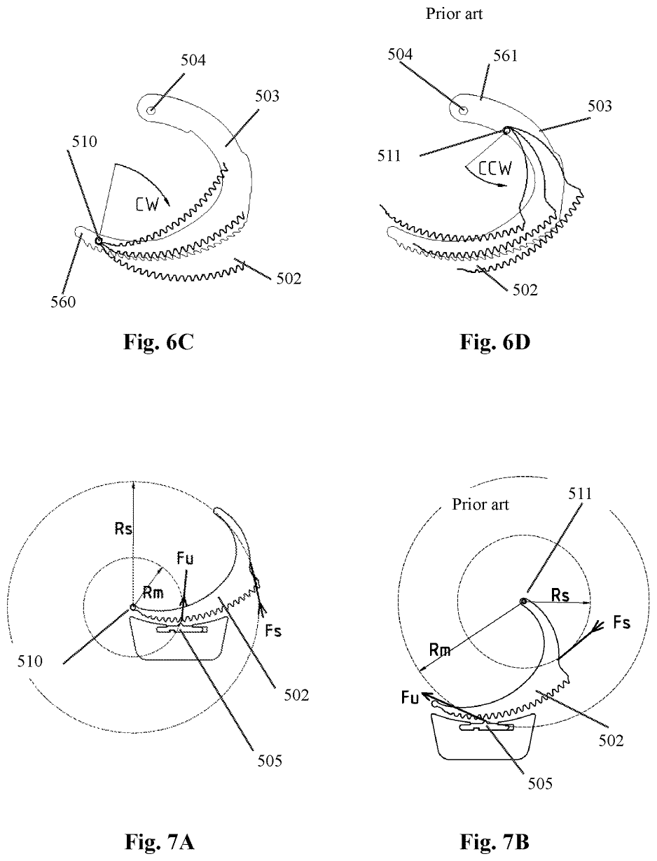

FIG. 6A is an illustration of the present invention, wherein rotation axis 510 of middle ratchet 502 is positioned at the left-most end of 502 and to near the small-end of the single strand 503. The middle ratchet 502 can rotate in both CW and CCW around axis 510 before engages with stop and/or meets any other object. In tightening of the handcuff, when 502 is pushed by resistant force 507 from inner side, 502 rotates around rotation axis 510 in CW until engages with the stop key 505, then 502 stops and further tightened is prevented.

It can be seen that the rotation axis 510 and the resistant force 507 are at the opposite sides of the stop key 505 when 502 is engaged with 505, and false activation does not exit.

FIG. 6B is an illustration of prior arts, wherein the axis 511 of the ratchet 502 is positioned at the up-right end of 502 and near the big-end of the single strand 503. The middle ratchet 502 can rotate in both CW and CCW around axis 511 before engages with stop key and/or meets any other object. In tightening of the handcuff, when 502 is pushed by the resistant force 507 from inner side, 502 rotates around axis 511 in CCW until engages with stop key 505, and then 502 stops and further tightened is prevented.

It can be seen that the axis 511 and the resistant force 507 is at the same side of the stop key 505 when 502 is engaged with 505, and false activation does exit.

It is to be noticed that the middle ratchet has two ends: the left-most end and the up-right end,

When a rotation axis is placed at one end, another end is a free end.

When rotation axis 510 is at the left-most end, the up-right end is a free end, as in the present invention.

When rotation axis 511 is at the up-right end, the left-most end is a free end, as in prior arts.

FIG. 6C, in present invention, an imaginary illustration of rotation trajectories of middle 502, only teeth of 502 are shown, wherein rotation axis 510 is at the left-most end of 502 and is near the small-end 560 of the single strand 503. The up-right end of 502 is then a free end.

FIG. 6D, in prior arts, an imaginary illustration of rotation trajectories of 502, only teeth of 502 are shown, wherein axis 511 is at the up-right end of 502 and is near the big-end 561 of the single strand 503. The left-most end of 502 is then a free end.

It can be seen that the differences of rotation trajectories between FIG. 6C and FIG. 6D are distinctive:
Rotation directions are opposite: CW vs CCW;
Movements are different: teeth rotate with almost no left-right movement in FIG. 6C, but teeth rotate and with right-left movement in FIG. 6D.

FIG. 7A is another illustration of present invention, wherein axis 510 is on the left-most of the middle ratchet 502, Rm is the radius/distance between stop key 505 and axis 510, Rs is the radius/distance between the contacting position of the spring on 502 and the axis 510, Fs is the tangential force of the spring pushing on 502. Fu is a reaction force on 502, which is through the position of stop key 505, and is a corresponding force to Fs. It is the force Fu that makes 502 disengaged with the stop key 505 or released from the stop key 505 and returns to its free position after resistant force 507 is removed. Wherein:

$$Fu = ( \frac{Rs}{Rm} ) Fs$$

Fu>Fs is always true because Rs>Rm in the present invention.

FIG. 7B is another illustration of prior arts, wherein the axis 511 is on the up-right of the middle ratchet 502, Rm is the radius/distance between the stop key 505 and the axis 511, Rs is the radius/distance between the contacting position of the spring on 502 and the axis 511, Fs is the tangential force of the spring pushing on 502. Fu is a reaction force, which is through the position of stop key 505, and is the corresponding force to Fs. It is the force Fu that makes 502 disengaged with the stop key 505, or released from the stop key 505 and returns to its free position after resistant force 507 is removed.

$$Fu = ( \frac{Rs}{Rm} ) Fs$$

Fu<Fs is always true because Rs<Rm in prior arts.

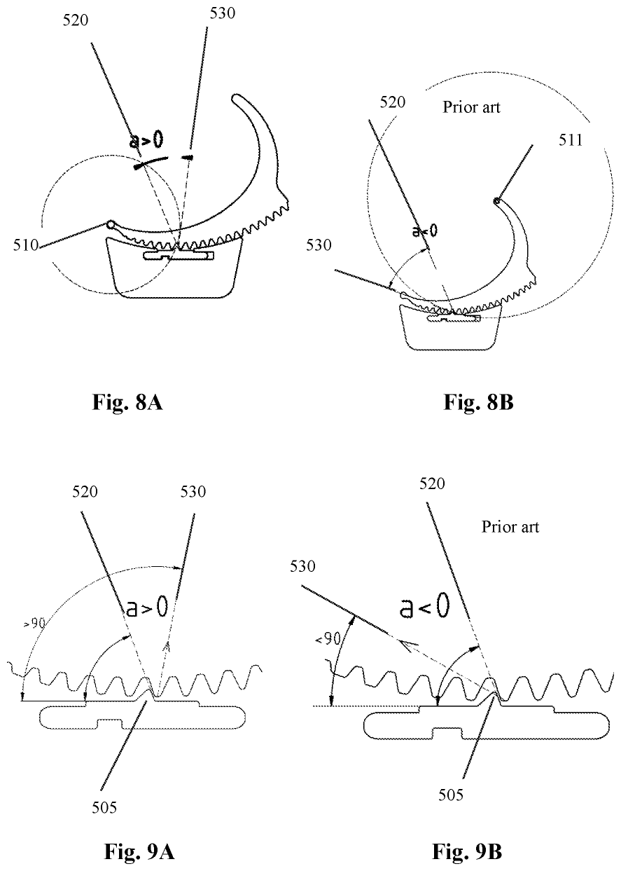

FIG. 8A is another illustration of present invention, wherein the axis 510 is on the left-most end of the middle ratchet 502, 520 is the angle of the right side of the stop key 505, 530 is the tangential angle, which is the direction of the CCW rotation trajectory of the tooth of 502 and is through the position of the stop key 505.

The tooth angle 520 of the stop key is defined as the angle of the right side of the tooth of the stop key, it is also simplified as the angle of the stop key 520, or the angle of the right side of the stop key.

Where a critical angle a is defined, it is the angle between 520 and 530, here a>0 because the angle 530 is bigger than the angle 520. When a>0, false activation is preventable.

FIG. 8B is another illustration of prior art, wherein the axis 511 is on the up-right end of the middle ratchet 502, 520 is the angle of the right side of the stop key 505, 530 is the tangential angle, which is the direction of the CW rotation trajectory of the tooth of 502 and is through the position of the stop key 505.

Where the critical angle a is the angle between 520 and 530, here a<0 because the angle 530 is smaller than the angle 520. When a<0, false activation is inevitable.

FIG. 9A is a magnified illustration of FIG. 8A near the portion of the engaged stop key in the present invention. The angle 520 of the stop key 505 is set at 60 degrees in this example, wherein a>0, and angle 530 is bigger than 90 degrees.

FIG. 9B a magnified illustration of FIG. 8B near the portion of the engaged stop key in prior arts. The angle 520 of the stop key 505 is set at 60 degrees in this example, wherein a<0, and angle 530 is smaller than 90 degrees.

There are two distinctive differences between FIG. 9A and FIG. 9B:
1), a>0 in the present invention, a<0 in prior arts.
2), angle 530 is >90 degrees in the present invention and <90 degrees in prior arts.

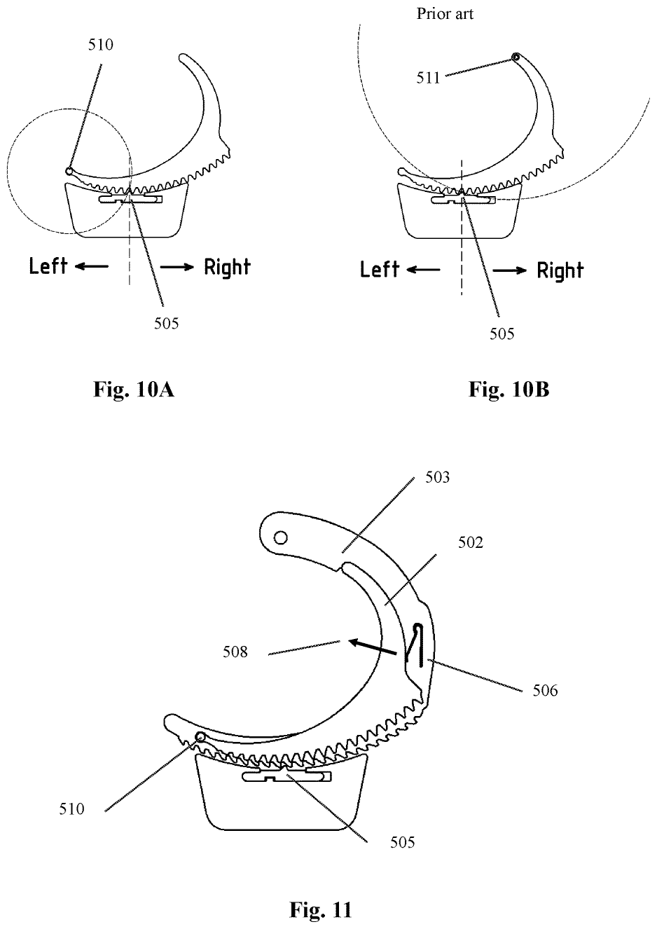

FIG. 10A and FIG. 10B are a comparison of the rotation trajectories of middle ratchet 502 through the stop key 505.

FIG. 10A is the present invention where the axis is 510. The middle ratchet rotates in CCW after force 507 is removed. The radius is much smaller.

FIG. 10B is the prior arts where the axis is 511. The middle ratchet rotates in CW after force 507 is removed. The radius is much bigger.

FIG. 11 is a portion of one embodiment of the present invention. 503 is a single strand, 502 is a middle ratchet, 506 is a spring, 510 is a rotation axis, and 505 is a stop key. 510 is at the left-most end of 502.

Wherein rotation axis 510 is mounted on the small-end of 503, 502 can rotate both clockwise and counter clockwise around 510 before stopped by any other part.

It is the force 508 applied on outside of 502 by spring 506 makes 502 rotating CCW around 510 to disengage with, or to release from stop key 505.

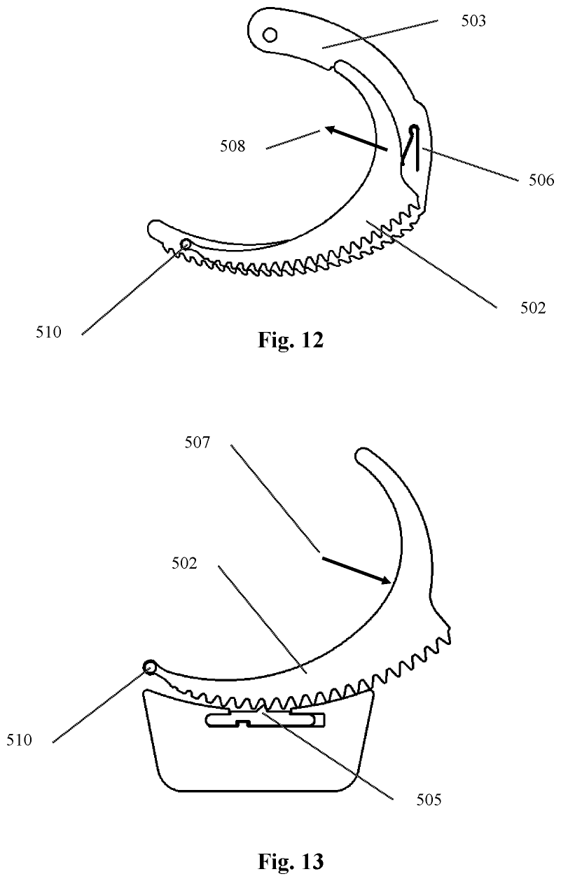

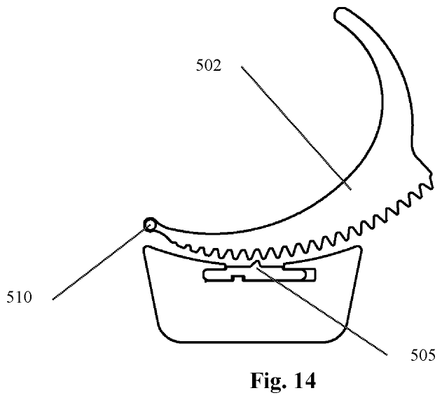

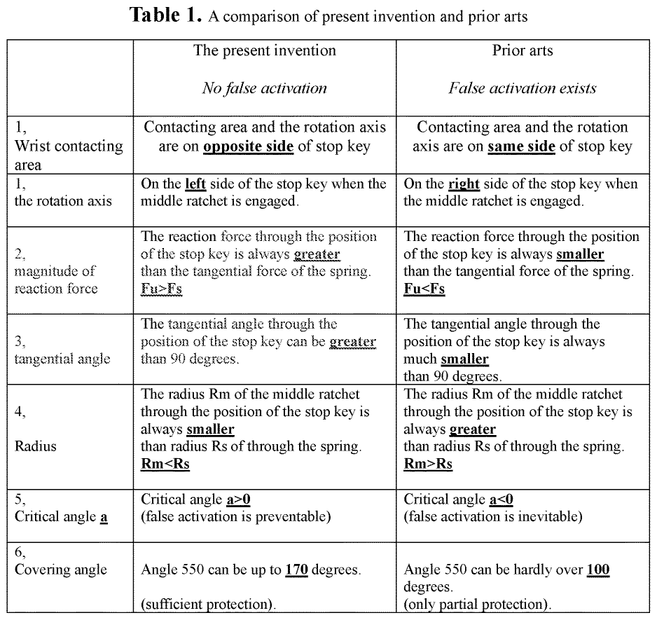

FIG. 12 and FIG. 14 are more illustrations of the present invention.

FIG. 12 is another illustration of the present invention. 503 is the single strand, 502 is the middle ratchet, 506 is the spring, 510 is the rotation axis of 502.

Wherein 502 is mounted on the small-end of 503, 502 can rotate both clockwise and counter clockwise around 510.

It is the force 508 applied on 502 by spring 506 makes 502 rotate CCW around 510.

FIG. 13 is another illustration of the present invention. 502 is the middle ratchet, 510 is the rotation axis of 502. 502 can rotate clockwise around 510 under force 507 to meet or engage with 12 stop key 505.

FIG. 14 is another illustration of the present invention. 502 is the middle ratchet, 510 is the rotation axis of 502. Wherein the ratchet 502 is engaged with the stop key 505.

502 can rotate counterclockwise around 510 after force 507 is removed.

Some distinctive differences and comparisons are shown in Table 1.

1. A reversed tension control mechanism,
the mechanism comprises a single strand, a middle ratchet, a spring, and a stop key,
the single strand has a rivet, a big-end, a small-end, and at least 9 teeth,
the big-end of the single strand is the end near the rivet,
the small-end of the single strand is the end far away from the rivet, it is the opposite end of the big-end,
the single strand rotates around the rivet when pushed,
the middle ratchet has a rotation axis, a left-most end and a up-right end, and at least 5 teeth,
the left-most end of the middle ratchet is connected to the small-end of the single strand via the rotation axis,
the up-right end of the middle ratchet is a free end, the up-right end of the middle ratchet is to rotate around the rotation axis when pushed,
the middle ratchet rotates clockwise around the rotation axis when pushed by a resistant force from inner side of the middle ratchet, when the teeth/tooth of the middle ratchet contact with the stop key, the middle ratchet engages with the stop key and stops rotating, any further clockwise rotation of both the middle ratchet and the single strand are prevented,
the single strand, the middle ratchet, the rotation axis and the stop key are arranged in such positions that when the middle ratchet engages with the stop key,
the rotation axis and the up-right end of the middle ratchet are at the opposite sides of the stop key, that is, the rotation axis is on the left side of the stop key and the up-right end of the middle ratchet is on the right side of the stop key.

2. A reversed tension control mechanism of claim 1,
spring the spring and the rotation axis are at the opposite sides of the stop key when the middle ratchet engages with the stop key.

3. A reversed tension control mechanism of claim 1,
when the middle ratchet is pushed by the spring,
a tangential force of the spring is created at the position where the middle rachet and the spring are contacting,
when the middle ratchet engages with the stop key, there is a reaction force of the middle ratchet, it is a corresponding force created by the spring through the position of the stop key,
the reaction force of the middle ratchet is greater than the tangential force of the spring.

4. A reversed tension control mechanism of claim 1,
the distance between the rotation axis and the position of the stop key is smaller than the distance between the rotation axis and the position where the middle rachet and the spring are contacting.

5. A reversed tension control mechanism of claim 1,
a tangential angle is defined as the angle of the middle ratchet moving through the position of the stop key when the middle ratchet rotates counterclockwise around the rotation axis,
the tangential angle is greater than 90 degrees.

6. A reversed tension control mechanism of claim 1,
all teeth of the middle ratchet are on the right side of the rotation axis when the middle ratchet engages with the stop key.

7. A reversed tension control mechanism of claim 1,
all teeth of the middle ratchet are equal in pitch,
all teeth of the single strand are equal in pitch,
the teeth's pitch of the middle ratchet is equal to the teeth's pitch of the single strand.

8. A reversed tension control mechanism of claim 1,
a tooth angle of the stop key is defined as the angle of the right side of the tooth of the stop key,
the tooth angle of the stop key varies from 30 degrees to 90 degrees.

9. A reversed tension control mechanism of claim 1,
the stop key has only one tooth.

10. A reversed tension control mechanism of claim 1,
the stop key has more than one tooth, the pitches of the teeth of the stop key are equal, and the teeth's pitch of the stop key is equal to the teeth's pitch of the middle ratchet.

11. A reversed tension control mechanism of claim 1,
wherein a critical angle a is defined, the critical angle a,
a=the tangential angle of the middle ratchet minus the tooth angle of the stop key,
a>0 must be true to prevent false activation.

12. A reversed tension control mechanism of claim 1,
the tooth angle of the stop key is never bigger than 90 degrees to prevent false activation.

13. A reversed tension control mechanism of claim 1,
the rotation axis of the middle ratchet and the resistant force applied from inner side of the middle ratchet are at the opposite sides of the stop key to prevent false activation.
